(19) United States
(12) Patent Application Publication
(10) Pub. No.: US 2021/0090038 A1
(43) Pub. Date: Mar. 25, 2021

(54) Method for Generating a Virtual Currency Depending on a Use of a Motor Vehicle and System

(71) Applicant: Daimler AG, Stuttgart (DE)

(72) Inventors: Thomas SAUER, Stuttgart (DE); Thomas Alexander HORAKH, Weil im Schoenbuch (DE)

(73) Assignee: Daimler AG, Stuttgart (DE)

(21) Appl. No.: 16/772,657

(22) PCT Filed: Dec. 7, 2018
(86) PCT No.: PCT/EP2018/083913

§ 371 Date: Jun. 12, 2020

(30) Foreign Application Priority Data
Dec. 13, 2017 (DE) 10 2017 011 489.7

(51) Int. Cl. G06Q 20/06; G06Q 20/38; G07C 5/08; G07C 5/00; G06Q 30/02; G06Q 50/06; G06Q 20/36; B60L 53/62; B60L 53/66

(52) U.S. Cl. CPC G06Q 20/0652; G06Q 20/389; G07C 5/08; G07C 5/008; G06Q 30/0201; G06Q 30/018; G06Q 20/3672; G06Q 20/3678; B60L 53/62; B60L 53/665; G06Q 50/06

(57) ABSTRACT

A method for generating a virtual currency depending on a use of a motor vehicle in which a piece of driving behavior information of a user of the motor vehicle is determined depending on at least one driving dynamic parameter of the motor vehicle and is transmitted to an electronic computing device. The virtual currency is generated by the electronic computing device depending on the transmitted piece of driving behavior information.

### BACKGROUND AND SUMMARY OF THE INVENTION

The invention relates to a method for generating a virtual currency depending on a use of a motor vehicle. The invention further relates to a system.

Various methods for generating a virtual currency are already known from the prior art. US 2016/0012424 A1 discloses a method for generating a virtual currency. Here, the virtual currency is determined depending on a behavior of a person depending on a product or a service.

Furthermore, US 2014/0344015 A1 discloses a method for generating a virtual currency depending on an online behavior of a user.

CN106570717 A discloses a virtual currency system for reducing greenhouse gases. A virtual greenhouse gas reduction currency is set up in an internet network. The virtual currency can be used for consumer spending at supermarkets.

The methods known from the prior art for generating a virtual currency, which are also known as “mining methods”, are very resource intensive, in particular in relation to the energy used for processing power.

The object of the present invention is to create a method and a system by means of which a user of a motor vehicle is encouraged to choose an environmentally friendly driving operation of the motor vehicle.

One aspect of the invention relates to a method for generating a virtual currency depending on a user of a motor vehicle. A piece of driver behavior information of a user of the motor vehicle is determined depending on at least one driving dynamic parameter of the motor vehicle and is transmitted to an electronic computing device. Depending on the transmitted driving behavior information, the virtual currency is generated by means of the electronic computing device.

This has the advantage that the virtual currency can be made available to the user depending on their driving behavior, and they can use the virtual currency, for example, for servicing services or other mobility services. The user is thus prompted to drive in a certain manner. In particular, it can be provided that a particularly environmentally friendly driving behavior leads to the electronic computing device generating the virtual currency for the user. Thus, the user can be motivated to operate the motor vehicle in particular in a manner that saves resources. This has a positive impact on the environment, since fewer pollutants are then generated, in particular, by the user of the motor vehicle, and thus the environment is negatively impacted to a lesser extent. In other words, by means of the virtual currency, an environmentally friendly behavior of the user is acknowledged, and the use of environmentally friendly mobility services is encouraged. The motor vehicle thus serves as a decentral part within the generation of the virtual currency, which is why a negative impact can be minimized during generation.

Switching to a higher gear in good time or using an engine breaking effect, for example, can be seen as environmentally friendly driving dynamic parameters. Similarly, it is possible that an environmentally friendly use of an air-conditioning device in the motor vehicle can be considered as the driving dynamic parameter. The list of these driving dynamic parameters is purely exemplary and should not be seen as exhaustive in any way.

In particular, it can be provided that information already used in the motor vehicle relating to the driving behavior is used to generate the driving behavior information, and thus devices installed in the motor vehicle can be accessed. Thus, the method can be carried out in a manner that particularly reduces the number of components. For example, the electronic computing device can generate the virtual currency by means of an Ecoscore method already present in the motor vehicle as driving behavior information. In particular, the virtual currency can also be referred to as mobiCOINs. The virtual currency can be generated for a driver of the motor vehicle or for the motor vehicle. For example, if the virtual currency is to be generated for the user, then the user can use the currency when using different motor vehicles. If the virtual currency is to be generated for the vehicle, then the virtual currency is generated specifically for the motor vehicle, such that, for example, several users can generate the virtual currency for the same motor vehicle.

According to an advantageous embodiment, a block string in the electronic computing device is used for the generation of the virtual currency. The block string is also referred to as block chain. Writing the block chain takes place, in particular, in a centralized manner on the electronic computing device. For example, one or a plurality of third parties can then also write the block chain blocks based on the driving behavior information triggered by the motor vehicles and thus process the transactions based on the virtual currency between the individual actors in an increasingly disseminated block chain. Thus, the advantages of the decentralization, in particular protection from manipulation, are successively achieved. By using the block chain, a resource-intensive proof-of-work method can be dispensed with, and the virtual currency can nevertheless be generated in a manner protected from forgery.

Furthermore, it has proved to be advantageous when the electronic computing device is formed as a central electronic computing device that is external to the vehicle. In particular, the virtual currency can thus be generated in a manner that saves resources. Furthermore, it can be prevented that the virtual currency decreases or increases in terms of price level as a result of generating too much virtual currency. In other words the virtual currency can be generated in a stable manner in terms of currency. The value creation process can thus be controlled by the central electronic computing device. Furthermore, it can be prevented that external third parties, for example, can unintentionally negatively affect the value creation process. It is thus also possible that, should a computing program on the electronic computing device have to be refreshed, this only has to be carried out on the one central electronic computing device. Thus, the virtual currency can be generated in a manner that saves resources, in particular, and is not labor intensive. This also contributes to a positive environmental balance.

It has furthermore proved to be advantageous when the driving dynamic parameter comprises a current energy consumption of the motor vehicle, which is compared to a reference energy consumption of the motor vehicle, wherein, depending on the comparison, the driving behavior information is determined. In particular, it can be determined by means of the energy consumption of the motor vehicle how environmentally friendly the driving behavior of the user is. The reference energy consumption can be, in particular, a standardized or predetermined value of the driving dynamic parameter, which can be determined, for example, under normal conditions with predetermined parameters such as, for example, with a predetermined speed with predetermined switching times. Should a user of the motor vehicle, for example, then already switch sooner or not meet the reference speed, then this leads, in particular, to a lower energy consumption in comparison to the reference energy consumption. In particular, this behavior that saves resources can then be acknowledged by the lower energy consumption being compared to the reference energy consumption and the driving behavior information being determined depending thereon and then the virtual currency being generated. In particular, it is provided that the lower the energy consumption in comparison to the reference energy consumption, the more virtual currency can be generated. Thus, it is made possible for a user of the motor vehicle to be encouraged to move the motor vehicle in a manner that saves resources, in particular, and is environmentally friendly.

It is also advantageous when a multitude of pieces of driving behavior information about a multitude of users is transferred to the electronic computing device, and the multitude of pieces of driving behavior information is taken into consideration when generating the virtual currency. In particular, it can be prevented that virtual currency is generated erroneously, and thus the price level of the virtual currency sinks or increases. Thus, the virtual currency can be generated in a value-stable manner, and thus the user of the motor vehicle can be reliably encouraged to move the motor vehicle in an environmentally friendly manner since the price level does not fall.

In an advantageous embodiment, a multitude of pieces of driving behavior information about a multitude of motor vehicles is transferred to the electronic computing device, and the multitude of pieces of driving behavior information is taken into consideration when generating the virtual currency. In particular, it can be prevented that virtual currency is generated erroneously, and thus the price level of the virtual currency sinks or increases. Thus, the virtual currency can be generated in a value-stable manner, and thus the user of the motor vehicle can be reliably encouraged to move the motor vehicle in an environmentally friendly manner since the price level does not fall.

It has proved to be advantageous when, with a multitude of pieces of driving behavior information about a multitude of motor vehicles and/or a multitude of user, a respective parameter characterizing the motor vehicle is also taken into consideration when generating the respective driving behavior information. In particular, the different driving dynamic parameters are independent of the parameter characterizing the motor vehicle. The driving behavior information is then generated in such a way that the parameter characterizing the motor vehicle is also taken into consideration, such that the driving behavior of the users can be determined independently of the motor vehicle itself and thus can be compared to other driving behavior of other users, such that different motor vehicles can be compared to different motorization and, for example, different aerodynamic values can be compared to one another, and, by means of this, the driving behavior can be in turn be compared to further driving behavior independent of the motor vehicle. Thus, a reliable determination of the driving behavior can be achieved with different motor vehicles.

According to a further advantageous embodiment, the driving behavior information is only determined when using a motor vehicle having an internal combustion engine or only with a motor vehicle having an internal combustion engine. Since the motor vehicles, in particular, with an internal combustion engine play a decisive role in environmental pollution by environmentally friendly driving behavior or have an influence on the reduction of environmental pollution, it has proved to be advantageous when only motor vehicles having an internal combustion engine are entitled to generate the virtual currency. Thus, users of a motor vehicle having an internal combustion engine are directly encouraged to display environmentally friendly driving behavior that thus saves resources. Thus, particular reliable driving behavior of the user that saves resources and protects the environment can be achieved, whereby a positive influence on the environment can be achieved.

Furthermore, it has proved to be advantageous when a charging behavior and/or draining behavior of an electrical energy store of the motor vehicle is determined as a driving-dynamic parameter for generating the driving behavior information. In particular, the motor vehicle can be provided as at least partially electrically operated. For this, the motor vehicle has an electrical energy store, which can be formed, in particular, as a traction battery and provides electrical energy for an electric drive of the motor vehicle. In particular, the motor vehicle is formed as an electric motor vehicle. Thus, by generating the virtual currency, the driver can be encouraged to save electrical energy of the energy store. Furthermore, by sparingly charging the energy store, in particular by means of long charging times with a low charging power, the lifetime of the electrical store can be extended. By carefully draining, for example by means of reserved driving behavior, the lifetime of the electrical energy store can also be extended. This contributes to the protection of the environment, such that the driver is motivated to drive in an environmentally friendly manner.

In addition, it can be provided that, with a hybrid vehicle, which has an internal combustion engine and an electrical drive, the driving behavior information is determined depending on the use of the internal combustion engine and depending on the use of the electrical energy store.

It is also advantageous when the user and/or the motor vehicle are registered and validated for the generation of the virtual currency by means of the electronic computing device. In particular, the registration and validation is already carried out before generating the virtual currency. In particular, a misuse can thus be prevented. Furthermore, the group of participants who are authorized to generate the virtual currency can be specifically accurately determined, such that an inflation or deflation of the virtual currency can be reliably controlled or prevented. Furthermore, it can thus be prevented that virtual currency can be generated by third parties, for example, who are not authorized to take part in the process. Thus, the misuse can be effectively limited. Furthermore, excessive speculation can thus be curbed. Thus, the virtual currency can be provided in a stable manner, such that a user of the motor vehicle can take part in the generation of the virtual currency in an improved manner and thus be encouraged to drive in an environmentally friendly manner.

A further aspect of the invention relates to a system for generating a virtual currency. The system has an electronic computing device and a motor vehicle, which has an evaluation device, by means of which a piece of driving behavior information of the motor vehicle can be determined depending on a driving-dynamic parameter detected by a detection device of the motor vehicle. The motor vehicle further has a communication device, by means of which the driving behavior information can be transmitted to the electronic computing device of the system. The virtual currency can be generated by means of the electronic computing device depending on the transmitted driving behavior information.

Advantageous embodiments of the method can be seen as advantageous embodiments of the system. The motor vehicle is formed, in particular, as a passenger vehicle. In particular, the motor vehicle can be provided with an internal combustion engine and/or an electric drive.

Further advantages, features and details of the invention emerge from the below description of preferred exemplary embodiments as well as by means of the drawings. The features and combinations of features mentioned in the description above as well as features and combinations of features mentioned in the description of the Figures below and/or shown individually in the Figures can be used not only in the respectively specified combination, but also in other combinations or individually without leaving the scope of the invention.

### BRIEF DESCRIPTION OF THE DRAWINGS

FIG. 1 is a schematic view of an embodiment of a system; and

FIG. 2 is a schematic flowchart of an embodiment of a method according to the invention.

### DETAILED DESCRIPTION OF THE DRAWINGS

The same or functionally similar elements are provided with the same reference numeral in the Figures.

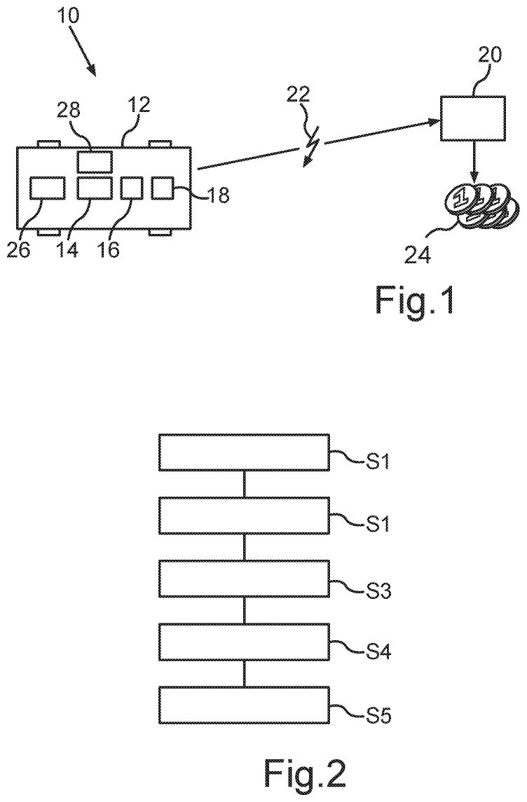

In a schematic top view, FIG. 1 shows an embodiment of a system 10. The system 10 comprises a motor vehicle 12. The motor vehicle 12 has an evaluation device 14 and a detection device 16. In particular, a driving dynamic parameter of the motor vehicle 12 can be detected by means of the detection device 16. For example, a current energy consumption of the motor vehicle 10 can be detected as the driving dynamic parameter. Similarly, it is possible that switching into a higher gear in good time or using an engine brake, for example, can be seen as driving dynamic parameters. Furthermore, it is possible that an environmentally friendly use of an air-conditioning device in the motor vehicle 12 can also be considered as a driving dynamic parameter. The list of these driving dynamic parameters is purely exemplary and should by no means be seen as exhaustive.

A piece of driving behavior information of the motor vehicle 12 can be determined by means of the evaluation device 14 depending on the detected driving dynamic parameter. Furthermore, the motor vehicle 12 has a communication device 18, by means of which the determined driving behavior information can be transmitted to an electronic computing device 20. In particular, the driving behavior information can be transmitted from the motor vehicle 12 to the electronic computing device 20 by means of a communication network 22, for example. Here, the communication network 22 can be a wireless communication network or a wire-connected communication network.

The electronic computing device 20 is formed, in particular, as a central electronic computing device external to the vehicle.

Then, depending on the transmitted driving behavior information, a virtual currency 24 can be generated by means of the electronic computing device 20.

In particular, it is provided that the driving behavior is evaluated in terms of the environmentally friendliness of the driving behavior. In particular, with particular environmentally friendly driving behavior, a piece of such driving behavior information can then be determined, such that the virtual currency 24 is generated for a user of the motor vehicle 12. For example, it can be provided that servicing services or mobility services can be used by means of the virtual currency 24. Thus, the user of the motor vehicle 12 is encouraged to move the motor vehicle 12 in a particularly environmentally friendly manner. This leads to a positive environmental balance.

In particular, it is provided that the motor vehicle 12 is formed as a passenger vehicle and has an internal combustion engine 26, by means of which the motor vehicle 12 can at least partially be operated. Furthermore, the motor vehicle 12 can then alternatively or additionally have an electric drive. For this, it is provided, in particular, that the motor vehicle 12 has an electric energy store 28 by means of which electrical energy can be provided for driving the electric drive. The electrical energy store 28 is formed, in particular, as a traction battery.

FIG. 2 schematically shows a flowchart of the course of the method according to the invention. In step S, a driving dynamic parameter of the motor vehicle 12 is determined by means of the detection device 16. In particular, it can be provided that, in step S, the driving dynamic parameter comprises a current energy consumption of the motor vehicle 12, wherein the current energy consumption is compared to a reference energy consumption of the motor vehicle 12, and the driving behavior information is determined depending on the comparison.

In particular, it is provided that the driving behavior information and the driving dynamic parameter is only determined when using motor vehicles 12 having internal combustion engines 26 or only with a motor vehicle 12 having an internal combustion engine 26.

Alternatively or additionally, charging behavior and/or draining behavior of the electrical energy store 28 of the motor vehicle 12 can be determined as the driving dynamic parameters for generating the driving behavior information. Thus, by generating the virtual currency 24, the driver can be encouraged to save electrical energy of the electrical energy store 28. Furthermore, by sparingly charging the electrical energy store 28, in particular by long charging times with a low charging power, the lifetime of the electrical energy store 28 can be prolonged. By sparingly draining, for example by reserved driving behavior, the lifetime of the electrical energy store 28 can also be prolonged. This contributes to protecting the environment, such that the driver is motivated to drive in an environmentally friendly manner.

Furthermore, it is provided, in particular, that the user and/or the motor vehicle 12 is registered and/or validated by means of the electronic computing device 20 for the generation of the virtual currency 24. Thus, it can be prevented that third parties who are not authorized to take part in the generation process of the virtual currency 24 generate the virtual currency 24 without permission. Thus, a misuse when generating the virtual currency 24 can be reliably prevented, such that the virtual currency 24 can be generated in a value-stable manner. This contributes to a higher degree of satisfaction and acceptance with the user, such that they are positively encouraged to display environmentally friendly driving behavior.

In step S2, it is provided that a piece of driving behavior information of the user of the motor vehicle 21 is determined depending on the detected driving dynamic parameter. In particular, it can be provided that a respective parameter characterizing the motor vehicle 12 can also be taken into consideration when generating the respective driving behavior information with a plurality of driving behavior information of a plurality of motor vehicles 12 and/or a plurality of users. For example, a power of the internal combustion engine 26 can be taken into consideration as the parameter characterizing the motor vehicle 12. Similarly, it is also possible that an aerodynamic value of the motor vehicle 12, for example, can also be taken into consideration when generating. Thus, different vehicles 12 can be compared to one another, such that the driving behavior only shows to the advantage reliably and fairly when generating the virtual currency 24.

In step S3, the determined driving behavior information is then transmitted to the electronic computing device 20, in particular wirelessly, by means of the communication device 18.

In step S4, it is provided in particular that a plurality of driving behavior information about a plurality of users is transferred to the electronic computing device 20, and the plurality of driving behavior information is taken into consideration when generating the virtual currency 24. In particular, it can then be prevented that a destabilization of the virtual currency 24 takes place, for example. Thus, the value creation process of the virtual currency 24 can be controlled via the electronic computing device 20. Thus, a value-stable virtual currency 24 can be generated which leads to a high acceptance with the user.

In particular, it is also provided in step S4 that a plurality of driver behavior information for a plurality of motor vehicles 12 is transferred to the electronic computing device 20, and the plurality of driving behavior information is taken into consideration when generating the virtual currency 24. Thus, a destabilization of the virtual currency 24 can also be prevented.

In step S5, it is provided that the virtual currency 24 is generated by means of the electronic computing device 20 depending on the transmitted driving behavior information. In particular, a block string in the electronic computing device 20 can be used for generating the virtual currency 24. In particular, a defective influence of the generation of the virtual currency 24 can be prevented by using the block string. The block string can also be referred to as the block chain.

The virtual currency 24 can, in particular, be paid out to a virtual wallet of the user, wherein the virtual currency 24 in turn can be used for servicing services and/or mobility services.

1.-11. (canceled)

12. A method for generating a virtual currency depending on a use of a motor vehicle, comprising the steps of:
determining a piece of driving behavior information of a user of the motor vehicle depending on a driving dynamic parameter of the motor vehicle;
transmitting the piece of driving behavior information to an electronic computing device; and
generating the virtual currency by the electronic computing device depending on the transmitted piece of driving behavior information.

13. The method according to claim 12, wherein a block string is used in the electronic computing device for generating the virtual currency.

14. The method according to claim 12, wherein the electronic computing device is a central electronic computing device external to the motor vehicle.

15. The method according to claim 12, wherein the driving dynamic parameter comprises a current energy consumption of the motor vehicle which is compared to a reference energy consumption of the motor vehicle and wherein the piece of driving behavior information is determined depending on a comparison of the current energy consumption of the motor vehicle to the reference energy consumption of the motor vehicle.

16. The method according to claim 12, wherein a plurality of pieces of driving behavior information about a plurality of users of the motor vehicle is transmitted to the electronic computing device and wherein the plurality of pieces of driving behavior information is taken into consideration when generating the virtual currency.

17. The method according to claim 12, wherein a plurality of pieces of driving behavior information about a plurality of motor vehicles is transferred to the electronic computing device and wherein the plurality of pieces of driving behavior information is taken into consideration when generating the virtual currency.

18. The method according to claim 12, wherein a parameter characterizing the motor vehicle is taken into consideration when determining the piece of driving behavior information.

19. The method according to claim 12, wherein the piece of driving behavior information is determined only when the motor vehicle has an internal combustion engine.

20. The method according to claim 12 further comprising the step of:
determining a charging behavior and/or a draining behavior of an electric energy store of the motor vehicle as the driving dynamic parameter.

21. The method according to claim 12, wherein the user and/or the motor vehicle is registered and validated by the electronic computing device for generating the virtual currency.

22. A system for generating a virtual currency, comprising:
an electronic computing device; and
a motor vehicle which includes an evaluation device, a detection device, and a communication device, wherein a piece of driving behavior information of the motor vehicle is determinable by the evaluation device depending on a driving dynamic parameter detected by the detection device and wherein the piece of driving behavior information is transmittable to the electronic computing device by the communication device;
wherein the virtual currency is generatable by the electronic computing device depending on the transmitted piece of driving behavior information.
